(19) United States
(12) Patent Application Publication
(10) Pub. No.: US 2025/0225426 A1
(43) Pub. Date: Jul. 10, 2025

(54) APPARATUS AND METHODS FOR THE GENERATION AND IMPROVEMENT OF EFFICIENCY DATA

(71) Applicant: The Strategic Coach Inc., Toronto (CA)

(72) Inventors: Barbara Sue Smith, Toronto (CA); Daniel J. Sullivan, Toronto (CA)

(73) Assignee: The Strategic Coach Inc., Toronto (CA)

(21) Appl. No.: 18/405,537

(22) Filed: Jan. 5, 2024

(51) Int. Cl. G06N 20/00

(52) U.S. Cl. CPC G06N 20/00

(57) ABSTRACT

An apparatus and method for the generation and improvement of efficiency data is disclosed. The apparatus includes at least a processor and a memory communicatively connected to the at least a processor. The memory instructs the processor to receive a user profile from a user, wherein the user profile comprises occupational data. The memory instructs the processor to determine efficiency data as a function of the occupational data. The memory instructs the processor to generate a plurality of graphical data as a function of the efficiency data. The memory instructs the processor to identify a plurality of efficiency clusters associated with the efficiency data as a function of the plurality of graphical data. The memory instructs the processor to identify an ideal arrangement of each cluster of the plurality of efficiency clusters as a function of the efficiency data and generate improvement data as a function of a comparison.

### FIELD OF THE INVENTION

The present invention generally relates to the field of artificial intelligence. In particular, the present invention is directed to an apparatus and a method for the generation and improvement of efficiency data.

### BACKGROUND

The automated detection and improvement of efficiency data has proven to be increasingly important and difficult. Attempts to automate the measurement and analysis of efficiency data have proven to be difficult due to the number of variables and inaccuracies that are involved. Current attempts at generating efficiency data often rely on manual data entry or limited automation, which can lead to errors and inconsistencies in the data.

### SUMMARY OF THE DISCLOSURE

In an aspect, an apparatus for the generation and improvement of efficiency data is disclosed. The apparatus includes at least a processor and a memory communicatively connected to the at least a processor. The memory instructs the processor to receive a user profile from a user, wherein the user profile comprises occupational data. The memory instructs the processor to determine efficiency data as a function of the occupational data. The memory instructs the processor to generate a plurality of graphical data as a function of the efficiency data. The memory instructs the processor to identify a plurality of efficiency clusters associated with the efficiency data as a function of the plurality of graphical data, wherein the plurality of efficiency clusters comprises a first efficiency cluster. The memory instructs the processor to identify an ideal arrangement of each cluster of the plurality of efficiency clusters as a function of the efficiency data. The memory instructs the processor to generate improvement data as a function of a comparison between the first efficiency cluster and the ideal arrangement. The memory instructs the processor to display the improvement data using a display device.

In another aspect, a method for the generation and improvement of efficiency data is disclosed. The method includes receiving, using at least a processor, a user profile from a user, wherein the user profile comprises occupational data. The method includes determining, using the at least a processor, efficiency data as a function of the occupational data. The method includes generating, using the at least a processor, a plurality of graphical data as a function of the efficiency data. The method includes identifying, using the at least a processor, a plurality of efficiency clusters associated with the efficiency data as a function of the plurality of graphical data, wherein the plurality of efficiency clusters comprises a first efficiency cluster. The method includes identifying, using the at least a processor, an ideal arrangement of each cluster of the plurality of efficiency clusters as a function of the efficiency data. The method includes generating, using the at least a processor, improvement data as a function of a comparison between the first efficiency cluster and the ideal arrangement. The method includes displaying the improvement data using a display device.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for the generation and improvement of efficiency data;

FIG. 2 is a block diagram of an exemplary machine-learning process;

FIG. 3 is a block diagram of an exemplary embodiment of an efficiency database;

FIG. 4 is a diagram of an exemplary embodiment of a neural network;

FIG. 5 is a diagram of an exemplary embodiment of a node of a neural network;

FIG. 6 an illustration exemplary embodiment of fuzzy set comparison;

FIG. 7 is an illustration of an exemplary embodiment of a chatbot;

FIG. 8 is an exemplary embodiment of a user interface;

FIG. 9 is an exemplary embodiment of a plurality of efficiency clusters;

FIG. 10 is a flow diagram of an exemplary method for the generation and improvement of efficiency data; and

FIG. 11 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to an apparatus and a method for the generation and improvement of efficiency data is disclosed. The apparatus includes at least a processor and a memory communicatively connected to the at least a processor. The memory instructs the processor to receive a user profile from a user, wherein the user profile comprises occupational data. The memory instructs the processor to determine efficiency data as a function of the occupational data. The memory instructs the processor to generate a plurality of graphical data as a function of the efficiency data. The memory instructs the processor to identify a plurality of efficiency clusters associated with the efficiency data as a function of the plurality of graphical data, wherein the plurality of efficiency clusters comprises a first efficiency cluster. The memory instructs the processor to identify an ideal arrangement of each cluster of the plurality of efficiency clusters as a function of the efficiency data. The memory instructs the processor to generate improvement data as a function of a comparison between the first efficiency cluster and the ideal arrangement. The memory instructs the processor to display the improvement data using a display device. Exemplary embodiments illustrating aspects of the present disclosure are described below in the context of several specific examples.

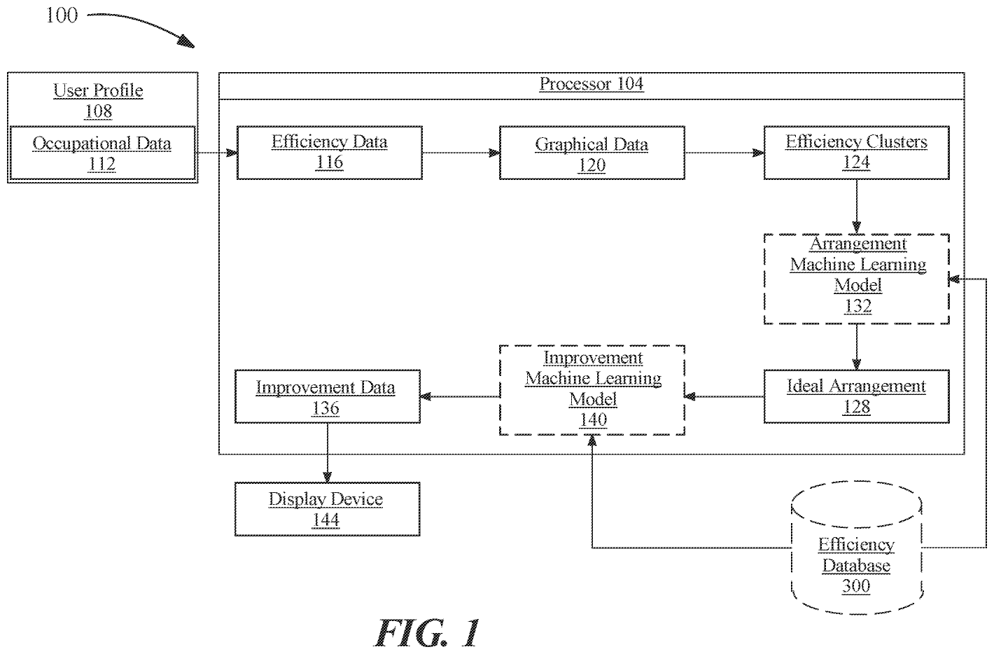

Referring now to FIG. 1, an exemplary embodiment of an apparatus 100 for the generation and improvement of efficiency data is illustrated. Apparatus 100 includes a processor 104. Processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a memory. Memory is communicatively connected to processor 104. Memory may contain instructions configuring processor 104 to perform tasks disclosed in this disclosure. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, apparatus, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example, and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, without limitation, via a bus or other facility for intercommunication between elements of a computing device. Communicative connecting may also include indirect connections via, for example, and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, processor 104 may be configured to extract a user profile 108 from a user. For the purposes of this disclosure, a “user profile” is a representation of information and/or data describing information associated with a user. A user profile 108 may be made up of a plurality of user data. As used in the current disclosure, “user data” is information associated with the user. A user profile 108 may be created by a processor 104, a user, or a third party. The user profile 108 may include any of the following personal information: age, weight, height, gender, credit, geographical location, financial information, medical history, marital status, relationship history, familial history, user goals, business goals, productivity goals, and the like. A user profile 108 may include information about the user's occupation. This may include the user's job title, salary, net worth, debts, revenue, gross income, net income, business debts, a list of business expenses, accounting information, and the like. In a non-limiting example, the user profile may be consistent with or substantially consistent with the user profile 108 described in U.S. patent application Ser. No. 18/141,320, Attorney Docket No 1452-001USU1, filed on Apr. 28, 2023, titled “METHOD AND AN APPARATUS FOR ROUTINE IMPROVEMENT FOR AN ENTITY,” which is incorporated by reference herein in its entirety.

With continued reference to FIG. 1, a user profile 108 may include occupational data 112 associated with the user. As used in the current disclosure, “occupational data” is data related to the occupation of the user. Occupational data 112 may include a listing of any task or set of tasks that the user is responsible for. Occupational data 112 may include a description of all of the tasks and sub-tasks that a user accomplishes in a given time period. This may include personal and professional tasks. Occupational data 112 may describe the responsibilities of a user, employee, manager, or owner. Occupational data 112 may represent internal or external tasks as it relates to the entity. Examples of occupational data 112 may include but are not limited to data describing managerial responsibilities, providing a service, making goods, maintaining a facility, interfacing with clients, accounting activities, product selection, ordering inventory, hiring/firing of employees, employee management, resource management, assigning tasks, and the like. Occupational data 112 may be entered into processor 104 by a user. Processor 104 may additionally be configured to generate occupational data 112 based on the purpose of the corporation, job descriptions of the employee, the number of goods promised, the number of services to be provided, and the like. This may be done using a machine learning model or fuzzy inference set. In an embodiment, occupational data 112 may be generated using a web crawler.

With continued reference to FIG. 1, processor 104 may receive occupational data 112 from a third-party source using an application programming interface (API). As used in the current disclosure, an “application programming interface” is a way for two or more computer programs to communicate with each other. An application programming interface may be a type of software interface, offering a service to other pieces of software. In contrast to a user interface, which connects a computer to a person, an application programming interface may connect computers or pieces of software to each other. An API may not be intended to be used directly by a person (the end user) other than a computer programmer who is incorporating it into the software. An API may be made up of different parts which act as tools or services that are available to the programmer. A program or a programmer that uses one of these parts is said to call that portion of the API. The calls that make up the API are also known as subroutines, methods, requests, or endpoints. An API specification may define these calls, meaning that it explains how to use or implement them. One purpose of API may be to hide the internal details of how a system works, exposing only those parts a programmer will find useful and keeping them consistent even if the internal details later change. An API may be custom-built for a particular pair of systems, or it may be a shared standard allowing interoperability among many systems. The term API may be often used to refer to web APIs, which allow communication between computers that are joined by the internet.

With continued reference to FIG. 1, processor 104 may be configured to generate an estimated completion time as a function of occupational data 112. An “estimated completion time,” as used herein, is an estimation of how long a task or a set of tasks associated with occupational data 112 will take to be completed. As used in the current disclosure, a “task” an activity or piece of work associated with the users. A task may be a single task or a set of tasks that is a part of a larger project. Generating an estimated completion time may include identifying a task or a set of tasks as a function of the occupational data 112. While identifying a specific task from a set of tasks, processor 104 may rely on a combination of manual programming and machine learning techniques. A task may need to be defined and categorized to identify a singular task. Once the tasks are defined, relevant features need to be extracted from the data associated with the task. Features can be specific attributes or characteristics that help differentiate one task from another. Processor 104 may be configured to identify a task or a set of tasks as a function of the feature identification and the task definition. In some embodiments, estimated completion time may be stored in a database, such as database 300. In some embodiments, processor 104 may estimate the completion time for a project by querying a database, where the database includes completion times for other entities and/or personnel. In an embodiment, processor 104 may estimate the completion time for a project based on a plurality of queried completion times. In a non-limiting example, processor 104 may query a database for the completion time for a task or a set of tasks, where the task may have different completion times for each person in the database. In this non-limiting example, processor 104 may be configured to generate an estimated completion time by averaging the different completion times received. It will be apparent to one of ordinary skill, upon reading this disclosure, of the many methodologies that can be used to ascertain an estimated completion time for a function.

With continued reference to FIG. 1., processor 104 may generate an estimated completion time using a lookup table. A “lookup table,” for the purposes of this disclosure, is a data structure, such as without limitation an array of data, that maps input values to output values. A lookup table may be used to replace a runtime computation with an indexing operation or the like, such as an array indexing operation. A look-up table may be configured to pre-calculate and store data in static program storage, calculated as part of a program's initialization phase or even stored in hardware in application-specific platforms. Data within the lookup table may include previous examples of estimated completion times correlated to occupational data 112. Data within the lookup table may be received from database 300. Lookup tables may also be used to generate estimated completion times by matching an input value to an output value by matching the input against a list of valid (or invalid) items in an array. In a non-limiting example, occupational data 112 may indicate that an entity has to accomplish a set of tasks or project. Examples of estimated completion times indicate that the completion time for a set of tasks or projects described by occupational data 112 has historically been between 45 minutes and 1 hour. A lookup table may look up occupational data 112 as an input and output estimated completion times indicating that the employee should complete the task in less than 1 hour. Processor 104 may be configured to “lookup” or input any data described within the entirety of the current disclosure. Data from the lookup table may be compared to examples of estimated completion times, for instance, and without limitation using string comparisons, numerical comparisons such as subtraction operations, or the like. Alternatively or additionally, a query representing elements of occupational data 112 may be submitted to the lookup table and/or a database.

With continued reference to FIG. 1, a user profile 108 may be received by processor 104 through user input. For example, and without limitation, the user or a third party may manually input user profile 108 using a graphical user interface of processor 104 or a remote device, such as for example, a smartphone or laptop. The user profile 108 may additionally be generated via the answer to a series of questions. The series of questions may be implemented using a chatbot, as described herein below. A chatbot may be configured to generate questions regarding any element of the user profile 108. In a non-limiting embodiment, a user may be prompted to input specific information or may fill out a questionnaire. In an embodiment, a graphical user interface may display a series of questions to prompt a user for information pertaining to the user profile 108. The user profile 108 may be transmitted to processor 104, such as via a wired or wireless communication, as previously discussed in this disclosure. The user profile 108 can be retrieved from multiple sources third-party sources including the user's inventory records, financial records, human resource records, past user profiles 108, sales records, user notes and observations, and the like. A user profile may be placed through an encryption process for security purposes.

With continued reference to FIG. 1, a user profile 108 may be generated using a smart assessment. As used in this disclosure, a “smart assessment” is a set of questions that inquire about the user's information as described in this disclosure. In some cases, questions within smart assessment may include selecting a selection from a plurality of selections as answers. In other cases, questions within smart assessment may include free user input as answers. In a non-limiting example, a smart assessment may include a question asking the user regarding project data; for instance, the question may be “What is the end goal of this project?” In some cases, a smart assessment may be in a form such as, without limitation, survey, transactional tracking, interview, report, events monitoring, and the like thereof. In some embodiments, a smart assessment may include a data submission of one or more documents from the user. A “data submission,” for the purpose of this disclosure, is an assemblage of data provided by the user as an input source. In a non-limiting example, data submission may include a user uploading one or more data collections to processor 104. Additionally, or alternatively, user profile 108 may include one or more answers to smart assessment.

With continued reference to FIG. 1, a user profile 108 may include user records. As used in the current disclosure, a “user record” is a document that contains information regarding the user. User records may include user credentials, reports, financial records, medical records, business records, Asset inventory, and government records (i.e. birth certificates, social security cards, and the like). A user record may additionally include an employee record. An employee record may include things like employee evaluations, human resource records, client files, invoices, timecards, driver's license databases, news articles, social media profiles and/or posts, and the like. User records may be identified using a web crawler. User records may include a variety of types of “notes” entered over time by the user, employees of the user, support staff, advisors, and the like. User records may be converted into machine-encoded text using an optical character reader (OCR).

Still referring to FIG. 1, in some embodiments, optical character recognition or optical character reader (OCR) includes automatic conversion of images of written (e.g., typed, handwritten, or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases, OCR may be an “offline” process, which analyses a static document or image frame. In some cases, handwriting movement analysis can be used as input for handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image components. Pre-processing process may include without limitation de-skew, de-speckle, binarization, line removal, layout analysis or “zoning,” line and word detection, script recognition, character isolation or “segmentation,” and normalization. In some cases, a de-skew process May include applying a transform (e.g., homography or affine transform) to the image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from the background of the image component. In some cases, binarization may be required for example if an employed OCR algorithm only works on binary images. In some cases. a line removal process may include the removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify a script allowing an appropriate OCR algorithm to be selected. In some cases, a character isolation or “segmentation” process may separate signal characters, for example, character-based OCR algorithms. In some cases, a normalization process may normalize the aspect ratio and/or scale of the image component.

Still referring to FIG. 1, in some embodiments, an OCR process will include an OCR algorithm. Exemplary OCR algorithms include matrix-matching process and/or feature extraction processes. Matrix matching may involve comparing an image to a stored glyph on a pixel-by-pixel basis. In some cases, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at the same scale as input glyph. Matrix matching may work best with typewritten text.

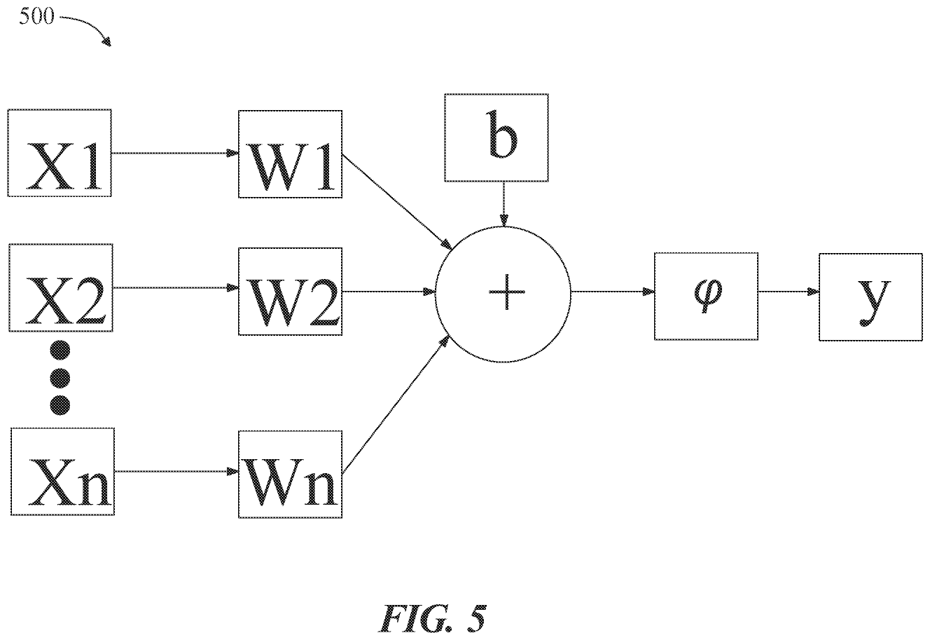

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted features can be compared with an abstract vector-like representation of a character, which might reduce to one or more glyph prototypes. General techniques of feature detection in computer vision are applicable to this type of OCR. In some embodiments, machine-learning processes like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 5-7. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

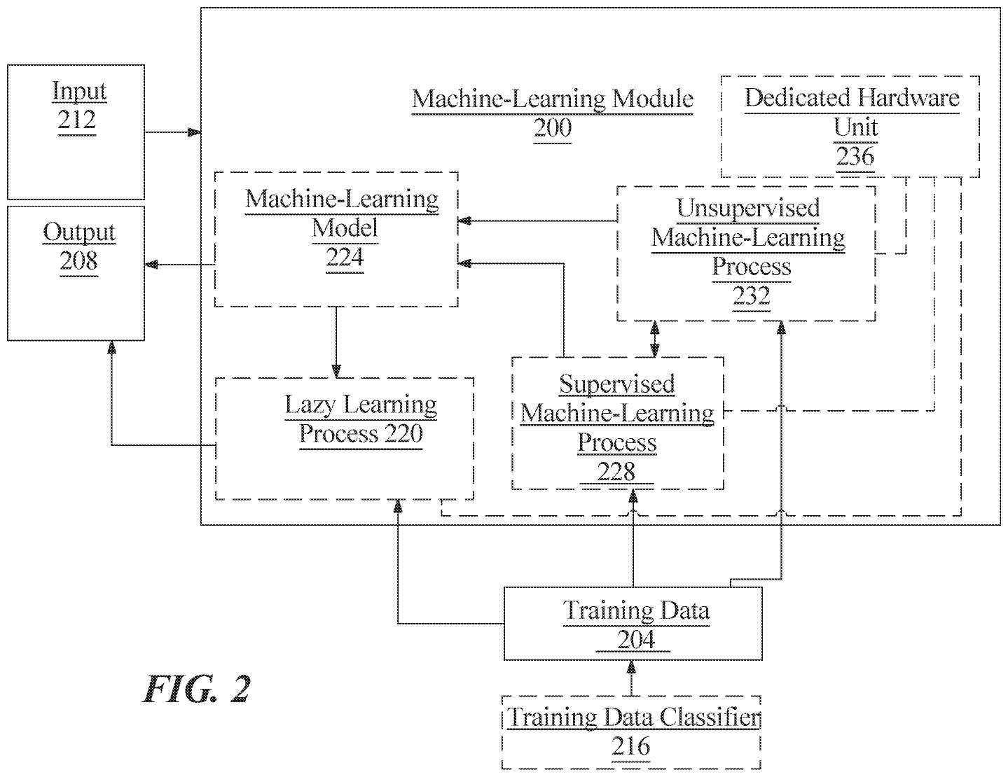

Still referring to FIG. 1, in some cases, OCR may employ a two-pass approach to character recognition. The second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIGS. 2, 4, and 5.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make use of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, user profile 108 may be generated using a web crawler. A “web crawler,” as used herein, is a program that systematically browses the internet for the purpose of Web indexing. The web crawler may be seeded with platform URLs, wherein the crawler may then visit the next related URL, retrieve the content, index the content, and/or measures the relevance of the content to the topic of interest. In some embodiments, processor 104 may generate a web crawler to compile the user profile 108 and user data. The web crawler may be seeded and/or trained with reputable websites, such as the user's business website, social media sites (i.e. LinkedIn, Facebook, TikTok, Instagram, and the like) to begin the search. A web crawler may be generated by a processor 104. In some embodiments, the web crawler may be trained with information received from a user through a user interface. In some embodiments, the web crawler may be configured to generate a web query. A web query may include search criteria received from a user. For example, a user may submit a plurality of websites for the web crawler to search to extract user records, inventory records, financial records, human resource records, past user profiles 108, sales records, user notes, and observations, based on criteria such as a time, location, and the like.

With continued reference to FIG. 1, processor 104 is configured to determine efficiency data 116 as a function of the occupational data 112. As used in the current disclosure, “efficiency data” is an element of data that is associated with the efficiency of the user while completing one or more tasks. The efficiency of the user may be described in terms of how a user spends their time. Efficiency data 116 may refer to the quantitative and qualitative measures used to evaluate how effectively and productively an individual utilizes their time, resources, and skills to accomplish tasks and contribute to the organization's goals. An efficient user may spend most of their time on task, whereas an inefficient user may spend a significant amount of time on unproductive tasks or waste time as compared to their peers when completing tasks. Efficiency data 116 may additionally refer to information that is collected and analyzed to evaluate the efficiency and output of a user. Efficiency data 116 may provide insights into an individual's performance and help assess their efficiency in various aspects of their work. Efficiency data 116 may include an evaluation of how well a user completes their assigned tasks. This data measures the time taken by an individual to complete specific tasks or assignments. It helps determine how efficiently they execute their responsibilities and meet deadlines. In some cases, efficiency data 116 may include insights into how effectively they allocate their time and identify areas where time is being wasted or underutilized. When evaluating the efficiency of the user efficiency data 116 may additionally take into consideration the quality of the user's work product. This may involve measuring the quantity and quality of work produced by an individual. This data may include metrics such as the number of projects completed, sales achieved, reports generated, or customer satisfaction ratings, and the like. Efficiency data 116 may include a determination how the error rate of the user. As used in the current disclosure, a “error rate” is the number of errors caused by the user while completing task. An error rate may indicate the frequency and severity of errors made by an individual. This data may help assess the users attention to detail, accuracy, and the need for improvements in their work processes. In some embodiments, processor 104 may generate efficiency data 116 by comparing the estimated completion time to occupational data 112. The occupational data 112 may describe the tasks that were assigned to the user and the estimated completion time will describe how long each task should take. This may be compared to how much time it took the user to complete the task, including how much time the user spent on task versus unproductive time. Excessive unproductive time may negatively affect the efficiency data 116. In some embodiments, efficiency data 116 may be expressed as a numerical score or a linguistic value. Efficiency data 116 may be represented as a score used to reflect the current productivity of the user. A non-limiting example, of a numerical scale, may include a scale from 1-10, 1-100, 1-1000, and the like, wherein a rating of 1 may represent a user who is unproductive, whereas a rating of 10 may represent a user who is highly productive. Examples of linguistic values may include, “Unproductive,” “Below Average Efficiency,” “Average Efficiency,” “Good Efficiency,” “Excellent Efficiency,” and the like. In some embodiments, a numerical score range may be represented by a linguistic value. As used in the current disclosure, a “numerical score range” is a range of scores that are associated with a linguistic value. For example, this may include a score of 0-2 representing “Unproductive” or a score of 8-10 representing “Excellent Efficiency.” A user's efficiency may be scored by classifying occupational data 112 to examples of efficiency data 116 from third parties who are similarly situated by experience, job title, task, and overall productivity.

With continued reference to FIG. 1, a numerical score range representing efficiency data 116 may be adjusted using linguistic values. Processor 104 may adjust the numerical score range according to the desired level of efficiency from the user. A numerical score range may be determined by comparing the desired level of production from the user to previous iterations of the numerical score ranges. Previous iterations' numerical score ranges may be taken from users who are similarly situated to the current user by experience, job title, task, and overall productivity, and the like. Previous iterations of a numerical score range may be received from database 300. A numerical score range may be generated using a range machine learning model. As used in the current disclosure, a “range machine-learning model” is a machine-learning model that is configured to identify a numerical score range. The range machine-learning model may be consistent with the machine-learning model described below in FIG. 2. Inputs to the range machine-learning model may include a user profile 108, occupational data 112, estimated completion times, examples of numerical score ranges, and the like. Outputs to the range machine-learning model may include a numerical score range. Range training data is a plurality of data entries containing a plurality of inputs that are correlated to a plurality of outputs for training a processor by a machine-learning process to correlate efficiency data 116 to examples of numerical score ranges. Range training data may be received from database 300. Range training data may contain information about user profile 108, occupational data 112, estimated completion times, examples of numerical score ranges, and the like. Range training data may comprise correlations between efficiency data 116 to examples of numerical score ranges. Machine learning model may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

With continued reference to FIG. 1, processor 104 may generate efficiency data 116 by classifying occupational data 112 into efficiency categories. As used in the current disclosure, “efficiency categories” is a category that is representative of one or more aspects of the user efficiency. Efficiency categories may include broad areas or aspects that contribute to overall efficiency and productivity. These categories help define and evaluate different aspects of an individual's work performance and identify areas for improvement. Non-limiting examples of efficiency categories may include task completion time, task completion rate, quality of tasks completed, quantity of tasks completed, time management, task prioritization, workflow optimization, supervision required, goal achievement, attention to detail, adaptability and flexibility, communication and collaboration and the like. In an embodiment, a processor 104 may be configured to generate a plurality of efficiency categories based on the available user profiles 108 and the occupational data 116. Processor 104 may generate a plurality of efficiency categories based on historical versions of the efficiency categories. Processor 104 may generate a plurality of efficiency categories by extracting relevant features, characteristics, or traits associated with each user profile 108 or the occupational data 112. Identification of features may depend on the nature of the occupation and the task that the user is instructed to complete. In other embodiments, a processor 104 be configured to receive a plurality of efficiency categories from a database such as database 300. In an embodiment, processor 104 may further classify occupational data 112 in categories based on the user's efficiency, such as efficient or inefficient and derivatives thereof. Processor 104 may identify the efficiencies or inefficiencies of the user by comparing the current user's occupational data 112 to previous iterations of occupational data 112. Processor 104 may receive historical examples of user profiles 108 and their corresponding occupational data 112 from a database such as database 300. Processor 104 may compare the current user profile 108 to the previous user profile 108 and their corresponding occupational data 112. User profiles 108 may be compared by experience, tenure, tasks completed, expected completion time, user credentials, and the like. Processor 104 may use the previous efficiencies or inefficiencies of past user profile 108 to classify elements of occupational data 112 of the current user profile 108 as efficient/inefficient. Each occupational datum 112 may represent a user profile 108. For instance, a first occupational datum may be representative of a first user profile, while a second occupational datum may be representative of a second user profile, and up to an nth occupational datum may be representative of an nth entity profile.

With continued reference to FIG. 1, processor 104 may be configured to generate the efficiency data 116 using an efficiency machine-learning model. As used in the current disclosure, an “efficiency machine-learning model” is a machine-learning model that is configured to generate efficiency data 116. The efficiency machine-learning model may be consistent with the machine-learning model and/or the classifier as described below in FIG. 2. Inputs to the efficiency machine-learning model may include user profile 108, occupational data 112, estimated completion times, and the like. Outputs to the efficiency machine-learning model may include efficiency data 116 tailored to the user profile 108. In some embodiments, an efficiency machine learning model may be configured to sort the occupational data 112 of into one or more efficiency categories. This may include sorting the occupational data 112 into categories that represent the efficiencies or inefficiencies of the user and the derivatives there of. Efficiency training data is a plurality of data entries containing a plurality of inputs that are correlated to a plurality of outputs for training a processor by a machine-learning process. In an embodiment, efficiency training data may comprise a plurality of occupational data 112 correlated to examples of efficiency data 116. Efficiency training data may be received from database 300. Efficiency training data may contain information regarding user profile 108, user data, occupational data 112, estimated completion times, and the like. Machine-learning models may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning models, learning vector quantization, and/or neural network-based machine-learning models.

With continued reference to FIG. 1, processor 104 is configured to generate a plurality of graphical data 120 as a function of the efficiency data 116. As used in the current disclosure, “graphical data” is a visual representation of information that conveys aspects of efficiency data 116. Graphical data 120 may refer to any type of data that is presented visually through graphical representations, such as charts, graphs, diagrams, maps, and other visual aids. These visual representations may represent complex data and are used to communicate information in a way that is easier to comprehend. Graphical data 120 can come in many forms, depending on the type of data being presented and the intended audience. For example, a line graph may be used to show the trend of a particular data set over time, while a pie chart may be used to display the distribution of different categories within a larger data set. Other types of graphical data 120 may include bar charts, scatter plots, heat maps, network diagrams, and the like. Graphical data 120 may include a graphical representation of one or more elements of occupational data 112 or efficiency data 116. In an embodiment, graphical data 120 may include a graphical representation of efficiency data 116 plotted as a single point or plurality of points representing efficiency data 116 over time. This may include a graphical representation of any of the characteristics and attributes of the entity represented above, wherein these attributes may be quantitative or qualitative in nature. In some embodiments, graphical data 120 may include plotting efficiency data 116 along a continuum. As used in the current disclosure, a “continuum” is a spectrum or a range of values, qualities, or attributes that exist along a single dimension or scale. A continuum may represent a continuous progression from one extreme to another, without any clear-cut boundaries or discrete categories. In a continuum, there are no distinct breakpoints or divisions, instead, there is a gradual transition or progression from one end to the other. In some embodiments, a continuum may represent qualitative traits that exist on a spectrum. In a non-limiting example, a continuum may represent the degree to which occupational data 112 or other traits of a user are efficient or inefficient as represented by efficiency data 116. Graphical data 120 may include a plurality of continuums, wherein each continuum represents one more trait or characteristic of a user. There may be a plurality of continuums representing various aspects of efficiency data 116 including error rates, completion times, work quality and the like. In some cases, each continuum of a plurality of continuums may be representative of one or more efficiency categories. In some embodiments, multiple continuums may be combined to generate an XY plot or an XYZ plot. Processor 104 may be configured to Add labels to the axes, a title, legends, and any other visual elements that provide context to graphical data. Processor 104 may additionally be configured to customize the appearance of data points, lines, or other graphical elements. In order to plot the graphical data 120 the processor 104 may be configured to organize the efficiency data in a suitable format. In a non-limiting example, this may involve having two sets of values: the independent variable (x-values) representing the continuum or range, and the dependent variable (y-values) representing the corresponding efficiency data. Processor 104 may identify and implement a plotting library to generate graphical data 120. Examples of plotting libraries may include but are not limited to Matplotlib for Python, ggplot for R, or Plotly for JavaScript. Processor 104 may then Pass the x and y values to the plotting library's function dedicated to creating scatter plots or line plots. This will generate a plot with the data points representing efficiency data along the continuum.

With continued reference to FIG. 1, processor 104 may generate graphical data 120 using a graphical machine machine-learning model. As used in the current disclosure, a “graphical machine machine-learning model” is a machine-learning model that is configured to generate graphical data 120 based on the efficiency data 116. Graphical machine machine-learning model may be consistent with the machine-learning model described below in FIG. 2. Inputs to the graphical machine machine-learning model may include user profiles 108, occupational data 112, efficiency data 116, efficiency categories, examples of graphical data 120, and the like. Outputs to the graphical machine machine-learning model may include graphical data 120 tailored to the efficiency data 116. Graphical training data may include a plurality of data entries containing a plurality of inputs that are correlated to a plurality of outputs for training a processor by a machine-learning process. In an embodiment, graphical training data may include a plurality of efficiency data 116 correlated to examples of graphical data 120. Graphical training data may be received from database 300. Graphical training data may contain information about user profiles 108, occupational data 112, efficiency data 116, efficiency categories, examples of graphical data 120, and the like. In an embodiment, Graphical training data may be iteratively updated as a function of the input and output results of past graphical machine machine-learning model or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model,

With continued reference to FIG. 1, graphical data 120 includes one or more efficiency clusters 124. As used herein, an “efficiency cluster” is a collection of data points representing at least one attribute or characteristic of efficiency of a user. An efficiency cluster 124 may include a grouping of data points that represents a collection of similar or related data points within a dataset. In other words, an efficiency cluster 124 is a subset of data points that exhibit some degree of similarity or proximity to each other, while being distinct from other clusters in the dataset. Identification of efficiency clusters 124 may be used to uncover patterns, structure, or relationships within a dataset such as efficiency data 116. Clusters can be formed based on various criteria, such as proximity in the feature space or similarity in attributes. By identifying clusters, processor 104 may gain insights into the underlying structure of the data and potentially discover meaningful patterns or subgroups within efficiency data 116. An attribute may include any or all metric associated with the efficiency of the user. Attributes may be described according to one or more efficiency categories. Examples of efficiency attributes may include time management, error rate, quality of work product produced, quantity of work product produced, consistency metrics, and the like. Efficiency clusters may include a single attribute of the user, or they may include more than one attribute. Efficiency clusters may include multiple related attributes. In a non-limiting example, an efficiency clusters may include a plurality of data points representing efficiency data 116, wherein the efficiency data 116 may represent the time management of a user. In some embodiments, an efficiency cluster 124 may represent the efficiency of the user and the degree to which said user has been efficient or inefficient. Processor 104 may identify an efficiency cluster 124 based on their similarity or homogeneity as it relates to the group of data points. An efficiency cluster 124 may represent groups of data points that share similar characteristics or properties. For example, an efficiency cluster 124 may represent group of tasks or a type of task that user has similar efficiency in completing. In some cases, a processor 104 may identify grouping and subgroupings based on the identification of one or more efficiency clusters 124. Efficiency clusters 124 may indicate the existence of distinct subpopulations or classes within the dataset. Clusters can reveal patterns or structures in the data that are not immediately apparent. By examining the characteristics of data points within a cluster, we may uncover relationships or associations that can be useful for further analysis or decision-making. For a non-limiting example, an efficiency cluster 124 may represent a group of the most efficient workers or a least efficient workers. Additionally, efficiency clusters 124 may be used to rank the skill of a worker as compared to their coworkers. In some embodiments, efficiency clusters 124 may be identified for a large groups of users within one entity. Processor 104 may compare the efficiency clusters 124 of a first entity to a second entity or the national averages to determine the overall efficiency of the entity. Each efficiency cluster 124 may represent one or more elements of graphical data 120. For instance, a first efficiency cluster may be representative of a first graphical datum, while a second efficiency cluster may be representative of a second graphical datum, and up to an nth efficiency cluster may be representative of an nth graphical datum.

With continued reference to FIG. 1, processor 104 may generate efficiency clusters 124 using a cluster machine machine-learning model. As used in the current disclosure, a “cluster machine machine-learning model” is a machine-learning model that is configured to generate efficiency clusters 124. Cluster machine machine-learning model may be consistent with the machine-learning model described below in FIG. 2. Inputs to the cluster machine machine-learning model may include user profiles 108, occupational data 112, efficiency data 116, efficiency categories, graphical data 120, examples of efficiency clusters 124, and the like. Outputs to the cluster machine machine-learning model may include efficiency clusters 124. Cluster training data may include a plurality of data entries containing a plurality of inputs that are correlated to a plurality of outputs for training a processor by a machine-learning process. In an embodiment, cluster training data may include a plurality of graphical data 120 correlated to examples of efficiency clusters 124. Cluster training data may be received from database 300. Cluster training data may contain information about user profiles 108, occupational data 112, efficiency data 116, efficiency categories, graphical data 120, examples of efficiency clusters 124, and the like. In an embodiment, cluster training data may be iteratively updated as a function of the input and output results of past cluster machine machine-learning model or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

Still referring to FIG. 1, the processor may be configured to generate a machine-learning model, such as cluster machine machine-learning model, using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. processor 104 may then calculate a likelihood table by calculating probabilities of different data entries and classification labels. processor 104 may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

Still referring to FIG. 1, processor 104 may be configured to generate a machine-learning model, such as cluster machine machine-learning model, using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 1, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm l=\sqrt{Σᵢ₌₀ⁿaᵢ²}, where aᵢ is attribute number experience of the vector. Scaling and/or normalization may function to make vector comparison independent of absolute quantities of attributes, while preserving any dependency on the similarity of attributes; this may, for instance, be advantageous where cases represented in training data are represented by different quantities of samples, which may result in proportionally equivalent vectors with divergent values.

With continued reference to FIG. 1, processor 104 may be configured to identify an ideal arrangement 128 of each cluster of the plurality of efficiency clusters 124 as a function of the efficiency data 116. As used in the current disclosure, an “ideal arrangement” is an optimal position of each efficiency cluster 124 on a graph to represent one or more desirable traits of a user. Desirable traits may include improved error rate, efficiency, quality of work product, quantity of work product, consistency, time management, and the like. In an embodiment, an ideal arrangement 128 may include an improvement of the efficiency clusters 124. This may include making the making the data points within each cluster more internally homogenous, externally diverse, meaningful, and reproducible, well-separated, and the like. Well-Separated clusters may be distinct and well-separated from other clusters, indicating clear boundaries and minimal overlap. This separation helps ensure that each cluster represents a different level or category of efficiency, allowing for meaningful comparisons and analysis. Homogenous clusters may include data points within each efficiency cluster that should be tightly grouped or densely packed together. This indicates that the data points within a cluster share high similarity or proximity in terms of efficiency, reinforcing the cluster's coherence. In some cases, the ideal arrangement 128 may include high intra cluster similarity, wherein the data points within each efficiency cluster may exhibit high similarity to each other in terms of efficiency. This means that the data points within a cluster should represent similar levels or values of efficiency, minimizing the internal variation or heterogeneity. In some cases, the ideal arrangement 128 of efficiency clusters may exhibit a hierarchical structure, where clusters at higher levels represent broader categories, and clusters at lower levels represent more specific subcategories of efficiency. Such an arrangement can provide a deeper understanding of the efficiency levels across different levels of granularity. The ideal arrangement 128 may reflect the ideal efficiency of each user or entity which is represented by the user profile. In a non-limiting example, the location of the efficiency clusters 124 may reflect that a user is suffering for inconsistencies in time management when completing a given task. This may mean that the distribution of the efficiency clusters 124 is spread out over a relatively large area to reflect the inconsistencies of the user. Processor 104 may generate an ideal arrangement 128 of the current efficiency clusters 124, wherein the ideal arrangement 128 comprises a more homogenous distribution of the data points. A more homogenous distribution may result in improved consistency from the user. In a non-limiting example, the location of the efficiency clusters 124 may reflect that a user is consistently inefficient when completing a given task. This may be reflected by the efficiency cluster 124 being located on a portion of a continuum which reflects moderately inefficient production by a user. An ideal arrangement 128 may include moving the efficiency cluster 124 to a portion of a continuum which reflects more efficient production from a user. Processor 104 may be configured to determine the position of the ideal arrangement 128 by comparing the efficiency clusters 124 of the current user to historical efficiency clusters 124 of users who gradually became more efficient. This may include identifying the increments by which a user improved their efficiency over a given time period. In some embodiments, this may additionally include identifying subgroups of users based on their production as a function of their historical efficiency cluster 124.

With continued reference to FIG. 1, processor 104 may generate an ideal arrangement 128 of efficiency clusters 124 using an arrangement machine machine-learning model 132. As used in the current disclosure, a “arrangement machine machine-learning model” is a machine-learning model that is configured to generate efficiency clusters 124. Arrangement machine machine-learning model 132 may be consistent with the machine-learning model described below in FIG. 2. Inputs to the arrangement machine machine-learning model 132 may include user profiles 108, occupational data 112, efficiency data 116, efficiency categories, graphical data 120, efficiency clusters 124, examples of ideal arrangements 128, and the like. Outputs to the arrangement machine machine-learning model may include an ideal arrangements 128 tailored to the efficiency clusters 124. Arrangement training data may include a plurality of data entries containing a plurality of inputs that are correlated to a plurality of outputs for training a processor by a machine-learning process. In an embodiment, arrangement training data may include a plurality of efficiency clusters 124 correlated to examples of ideal arrangements 128. Arrangement training data may be received from database 300. Arrangement training data may contain information about user profiles 108, occupational data 112, efficiency data 116, efficiency categories, graphical data 120, efficiency clusters 124, examples of ideal arrangements 128, and the like. In an embodiment, arrangement training data may be iteratively updated as a function of the input and output results of past arrangement machine machine-learning model or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

With continued reference to FIG. 1, processor 104 is configured to generate improvement data 136 as a function of a comparison between the first efficiency cluster and the ideal arrangement 128. As used in the current disclosure, “improvement data” is one or more suggestions regarding the improvement of the efficiency data 116. Improvement data 136 may be configured to improve the efficiency data 116 to generate the ideal arrangement 128 of efficiency clusters. Improvement data 136 may include an indication of the areas wherein the user is deemed to be inefficient and ways to improve those inefficiencies. Improvement data 136 may include a suggestion to the user to set one or more efficiency goals, prioritize certain tasks, improvement of time management, minimize distractions, delegate tasks, outsource tasks, and the like. Additional suggestions may include suggestions to improve the deficiencies of the user/entity. Suggestions may regard topics such as resource management, inventory management, employee management, business management, and the like. Improvement data 136 may include instructions to add or remove partnerships for the overall wellbeing of the business. Improvement data 136 may be a representation of information or data feedback related to achieving the endpoint element. Improvement data 136 may include instructions describing steps or processes the user may take to achieve improvement of the efficiency data 116. Improvement data 136 may include information regarding how a user spent his/her time, these may be separated by task or time increments. Improvement data 136 may describe the how engaged the user is at any given time. Engagement of the user may refer to the amount of time a user spends on a task and the percentage of that time a user is actively engaged in completing that task. For example, and without limitation, if a user is tasked with completing a report. Improvement data 136 may describe how long it takes a user to draft a report and how much time the user should spend on drafting the report to be considered efficient. Additionally, improvement data 136 may describe tangible ways by which the user can improve his or her efficiency in drafting this report. This may include suggesting the user look at past reports to streamline the drafting process or using tools such as a large language model to assist in drafting this report. In one or more embodiments, improvement data 136 may include parameter changes. For the purposes of this disclosure, “parameter changes” are instructions or data including recommendations or adjustments to a user profile. For instance, parameter changes may include instructions to a user that the user may implement to increase the user's capability, and thus chances, of improving efficiency data 116. In one or more embodiments, parameter changes may include one or more instructions to favorably or positively adjust (e.g., increase) the score of the efficiency data 116. Thus, parameter changes may include feedback functions that provide parameter alterations (e.g., instructions) that a user may follow to create a more desirable aptitude measurement and, therefore, achieve or more quickly achieve improvement of efficiency data 116.

With continued reference to FIG. 1, processor 104 may compare a first efficiency cluster and an ideal arrangement 128 using an improvement machine-learning model 140. As used in the current disclosure, an “improvement machine-learning model” is a machine-learning model that is configured to generate improvement data 136 based on the comparison of a first efficiency cluster and an ideal arrangement 128. Improvement machine-learning model 140 may be consistent with the machine-learning model described below in FIG. 2. Inputs to the improvement machine-learning model 140 may include a plurality of user profiles 108, occupational data 112, efficiency data 116, efficiency categories, graphical data 120, efficiency clusters 124, first efficiency cluster, ideal arrangement 128, examples of improvement data 136, and the like. Outputs to the improvement machine-learning model 140 may include improvement data 136 tailored to the comparison of the first efficiency cluster and the ideal arrangement 128. A comparison of the first efficiency cluster and an ideal arrangement 128 may be a comparison to determine how close an efficiency cluster is from the ideal arrangement 128. This may provide an indication to processor 104 of a need for improvement of the user. This may be done by comparing the current position of the data points to their ideal position as a reflected by the ideal arrangement 128. In an embodiment, the comparison may include an identification of how the inefficiencies of the first efficiency cluster would be improved if it were moved to the ideal arrangement 128. Improvement training data may include a plurality of data entries containing a plurality of inputs that are correlated to a plurality of outputs for training a processor by a machine-learning process to correlate a first efficiency cluster and an ideal arrangement 128 to examples of opportunity data 116. In an embodiment, improvement training data may include a plurality of first graphical data and a plurality of second graphical data to examples of improvement data 136. Improvement training data may be received from database 300. Improvement training data may contain information about user profiles 108, occupational data 112, efficiency data 116, efficiency categories, graphical data 120, efficiency clusters 124, first efficiency cluster, ideal arrangement 128, examples of improvement data 136, and the like. In an embodiment, improvement training data may be iteratively updated as a function of the input and output results of past improvement machine-learning model 140 or any other machine-learning model mentioned throughout this disclosure.

With continued reference to FIG. 1, processor 104 identifies the plurality of improvement data 136 as a function of a comparison between the first efficiency cluster and the ideal arrangement 128 using a fuzzy inference. As used in the current disclosure, a “fuzzy inference” is a method that interprets the values in the input vector (i.e., first efficiency cluster and ideal arrangement 128.) and, based on a set of rules, assigns values to the output vector. A set of fuzzy rules may include a collection of linguistic variables that describe how the system should make a decision regarding classifying an input or controlling an output. Fuzzy inference rules operate on fuzzy sets and provide a framework for mapping input variables to output variables through linguistic rules. Fuzzy inference rules may operate using linguistic variables, which represent imprecise or vague concepts rather than precise numerical values. Linguistic variables are defined by membership functions, which describe the degree of membership or truth for different linguistic terms or categories. In a non-limiting example, a linguistic variable “Efficiency” may have linguistic terms like “High Efficiency,” “Moderate Efficiency,” and/or “Low Efficiency,” each with its corresponding membership function. A fuzzy inference rule typically follows a conditional “IF-THEN” structure. It consists of an antecedent (IF part) and a consequent (THEN part). The antecedent specifies the conditions or criteria based on which the rule will be applied, and the consequent determines the output or conclusion of the rule. In a non-limiting example, of a fuzzy inference rule if a first efficiency cluster is a “Low Efficiency” and the represents a “Moderate Efficiency,” then the improvement data 136 may include a suggestion of 5 hours of efficiency training per month. In another non-limiting example, of a fuzzy inference rule if a first efficiency cluster is “Moderate Efficiency” and the ideal arrangement 128 represents “High Efficiency,” then the improvement data 136 may include a suggestion of time saving tips to improve the users efficiency. Using fuzzy inference rules like the rule mentioned herein above, we can compare the inefficiencies/efficiencies of a first efficiency cluster to the inefficiencies/efficiencies of ideal arrangement 128 to assess the need for improvement of the user. The linguistic terms used (“High Efficiency,” “Moderate Efficiency,” and “Low Efficiency”) are fuzzy sets that represent imprecise concepts rather than precise numerical values. The specific membership functions for these linguistic terms would need to be defined based on the context and criteria relevant to the comparison. When applying a fuzzy inference rule, the membership degrees for the linguistic terms “High” and “Moderate” are determined based on the actual asset and liability values of each entity. Fuzzy logic operators like AND, OR, and NOT can be used to combine the membership degrees and evaluate the rule's activation strength. In an embodiment, the improvement data 136 6 may be determined by a comparison of the degree of match between a first fuzzy set and a second fuzzy set, and/or single values therein with each other or with either set, which is sufficient for purposes of the matching process.

Still referring to FIG. 1, improvement data 136 may be determined as a function of the intersection between two fuzzy sets, wherein each fuzzy set may be representative of a first efficiency cluster and an ideal arrangement 128 respectively. Comparing the first efficiency cluster and an ideal arrangement 128 may include utilizing a fuzzy set inference system as described herein below, or any scoring methods as described throughout this disclosure. For example, without limitation, processor 104 may use a fuzzy logic model to determine improvement data 136 as a function of fuzzy set comparison techniques as described in this disclosure. In some embodiments, each piece of information associated with a first efficiency cluster may be compared to an ideal arrangement 128, wherein the improvement data 136 may be represented using a linguistic variable on a range of potential numerical values, where values for the linguistic variable may be represented as fuzzy sets on that range; a “good” or “ideal” fuzzy set may correspond to a range of values that can be characterized as ideal, while other fuzzy sets may correspond to ranges that can be characterized as mediocre, bad, or other less-than-ideal ranges and/or values. In embodiments, these variables may be used to compare a first efficiency cluster and an ideal arrangement 128 to determine the improvement data 136 specifics to the attributes represented within a plurality of user profiles 108. A fuzzy inferencing system may combine such linguistic variable values according to one or more fuzzy inferencing rules, including any type of fuzzy inferencing system and/or rules as described in this disclosure, to determine a degree of membership in one or more output linguistic variables having values representing ideal overall performance, mediocre or middling overall performance, and/or low or poor overall performance; such mappings may, in turn, be “defuzzified” as described in further detail below to provide an overall output and/or assessment.

With continued reference to FIG. 1, processor 104 may be configured to generate a notification as a function of efficiency data 116 and improvement data 136. As used in the current disclosure, a “notification” is a message or alert that informs the users about a particular event or update. Notifications can take various forms, such as a pop-up window, sound, vibration, or banner displayed on a device's lock screen or notification center. A notification may include an audio notification, visual notification, haptic notification, textual notification, or any combination thereof. A notification may indicate to a user that they are being unproductive, or they have fallen below an efficiency threshold. Notifications may take the form of a push notification on a user device, such as a smart phone, laptop, computer, or tablet. A notification may be generated if a user's efficiency data 116 falls below an efficiency threshold. A notification may be generated to notify them that their improvement data 136 is ready for review. As used in the current disclosure, an “efficiency threshold” is the level of productivity required for a person to be considered efficient in their job or task. This threshold may be determined by the specific expectations and goals set by an employer or individual. In a non-limiting example, if an employer expects their employees to complete a certain amount of work within a given timeframe, then the efficiency threshold would be the minimum level of work output required to meet those expectations. Similarly, in a personal project, an efficiency threshold may be the amount of work or progress that needs to be made in order to achieve a specific goal or deadline. The efficiency threshold may vary depending on the context and the individual's abilities, skills, and experience. It can also change over time as expectations and goals evolve. Generally, the goal of an efficiency threshold is to ensure that individuals are working at a level that meets the demands of their job or task and contributes to their overall success.

Still referring to FIG. 1, processor 104 may be configured to display the improvement data 136 using a display device 144. As used in the current disclosure, a “display device” is a device that is used to display content. A display device 144 may include a user interface. A “user interface,” as used herein, is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof, and the like. A user interface may include a smartphone, smart tablet, desktop, or laptop operated by the user. In an embodiment, the user interface may include a graphical user interface. A “graphical user interface (GUI),” as used herein, is a graphical form of user interface that allows users to interact with electronic devices. In some embodiments, GUI may include icons, menus, other visual indicators, or representations (graphics), audio indicators such as primary notation, and display information and related user controls. A menu may contain a list of choices and may allow users to select one from them. A menu bar may be displayed horizontally across the screen such as pull down menu. When any option is clicked in this menu, then the pull down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access. Information contained in user interface may be directly influenced using graphical control elements such as widgets. A “widget,” as used herein, is a user control element that allows a user to control and change the appearance of elements in the user interface. In this context a widget may refer to a generic GUI element such as a check box, button, or scroll bar to an instance of that element, or to a customized collection of such elements used for a specific function or application (such as a dialog box for users to customize their computer screen appearances). User interface controls may include software components that a user interacts with through direct manipulation to read or edit information displayed through user interface. Widgets may be used to display lists of related items, navigate the system using links, tabs, and manipulate data using check boxes, radio boxes, and the like.

With continued reference to FIG. 1, processor 104 may be configured to display the improvement data 136 within a graphical user interface data structure. As used in the current disclosure, a “graphical user interface (GUI) data structure” refers to the organization and representation of data within a GUI framework. The GUI data structures may be configured to represent and manage collections of data. For example, tables or lists may utilize arrays, linked lists, or other data structures to store and manipulate their data items. GUI data structures may provide a structured representation of the data being displayed or edited in the GUI, allowing for efficient manipulation and synchronization with the underlying data source. A GUI data structure may organize data to be displayed into a hierarchical structure. This hierarchy represents the containment and nesting relationships among various components. For example, a window may contain panels, which in turn may contain buttons or text fields. This hierarchical structure allows for easy management and manipulation of the interface elements. GUI data structure may employ layout managers to determine the positioning and sizing of components within a container. Layout managers use specific data structures, such as grids, trees, or linked lists, to manage the placement and alignment of components based on layout rules or constraints.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example, training data may include range training data which contain a plurality of efficiency data as input correlated to a plurality of numerical score ranges. As another non-limiting illustrative example, training data may also include efficiency training data which contain a plurality of occupational data as input correlate to a plurality of examples of efficiency data as output. Other exemplary training data used by machine-learning module 200 may further include graphical training data, cluster training data, arrangement training data, and improvement training data as described above in this disclosure.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data (i.e., efficiency training data), for instance, occupational data to a plurality of tasks and sub-tasks as described above in this disclosure. By classifying training data, machine-leaning module 200 may build models specific to each category (i.e., sub-population) which allow for a more detailed analysis of each group's behavior, leading to a better fit of machine-learning model to classified data. Additionally, or alternatively, impact of noise and/or outliers may be reduced by classifying training data; for instance, and without limitation, each sub-population may have its own trends and/or patterns that may be better captured when they are analyzed separately by more than one machine-learning models.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include a plurality of efficiency clusters and ideal arrangements as described above as inputs, a plurality of opportunity data as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

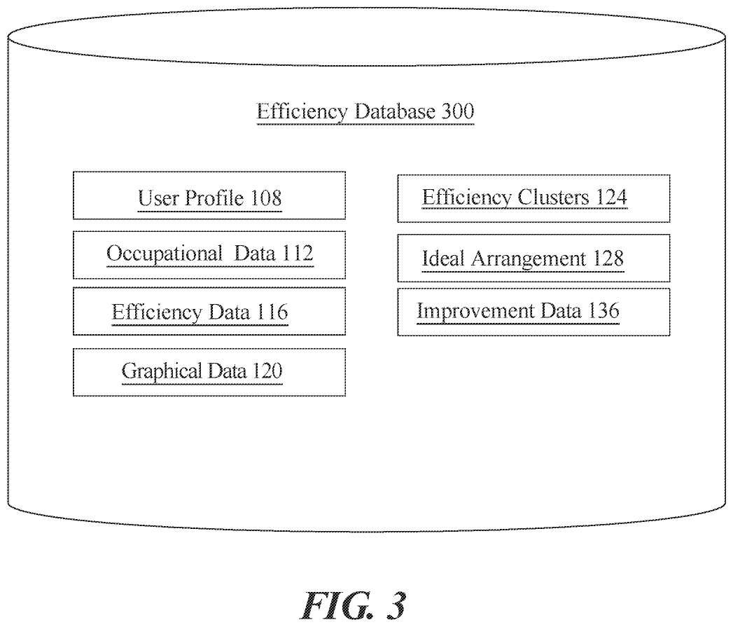

Now referring to FIG. 3, an exemplary efficiency database 300 is illustrated by way of block diagram. In an embodiment, any past or present versions of data disclosed herein may be stored within including user profiles 108, occupational data 112, efficiency data 116, efficiency categories, graphical data 120, efficiency clusters 124, first efficiency cluster, ideal arrangement 128, examples of improvement data 136, and the like. Processor 104 may be communicatively connected with efficiency database 300. For example, in some cases, database 300 may be local to processor 104. Alternatively or additionally, in some cases, database 300 may be remote to processor 104 and communicative with processor 104 by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local servers or personal computers. A “mesh network” as used in this disclosure is a local network topology in which the infrastructure processor 104 connect directly, dynamically, and non-hierarchically to as many other computing devices as possible. A “network topology” as used in this disclosure is an arrangement of elements of a communication network. Efficiency database 300 may be implemented, without limitation, as a relational database, a key-value retrieval database such as a NOSQL database, or any other format or structure for use as a database that a person skilled in the art would recognize as suitable upon review of the entirety of this disclosure. Efficiency database 300 may alternatively or additionally be implemented using a distributed data storage protocol and/or data structure, such as a distributed hash table or the like. Efficiency database 300 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

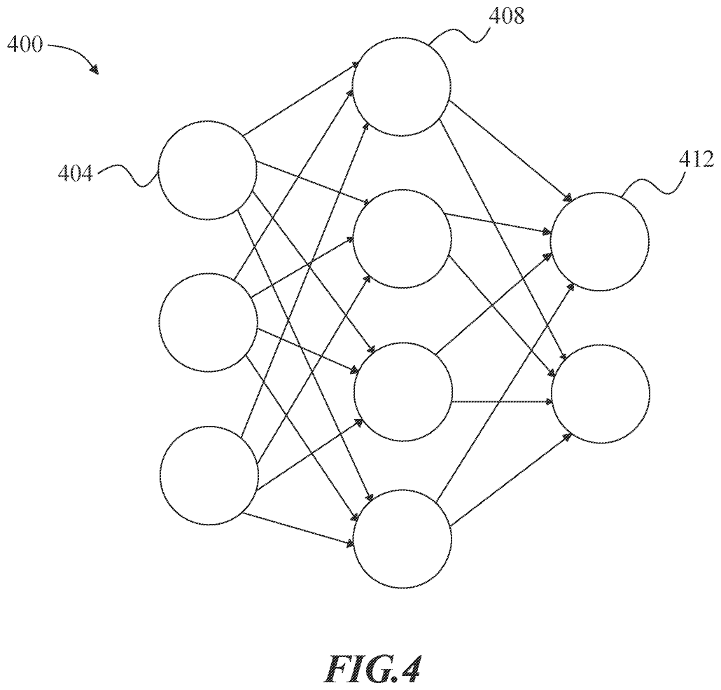

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

Referring now to FIG. 5, an exemplary embodiment of a node of a neural network is illustrated. A node may include, without limitation, a plurality of inputs xᵢ that may receive numerical values from inputs to a neural network containing the node and/or from other nodes. Node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

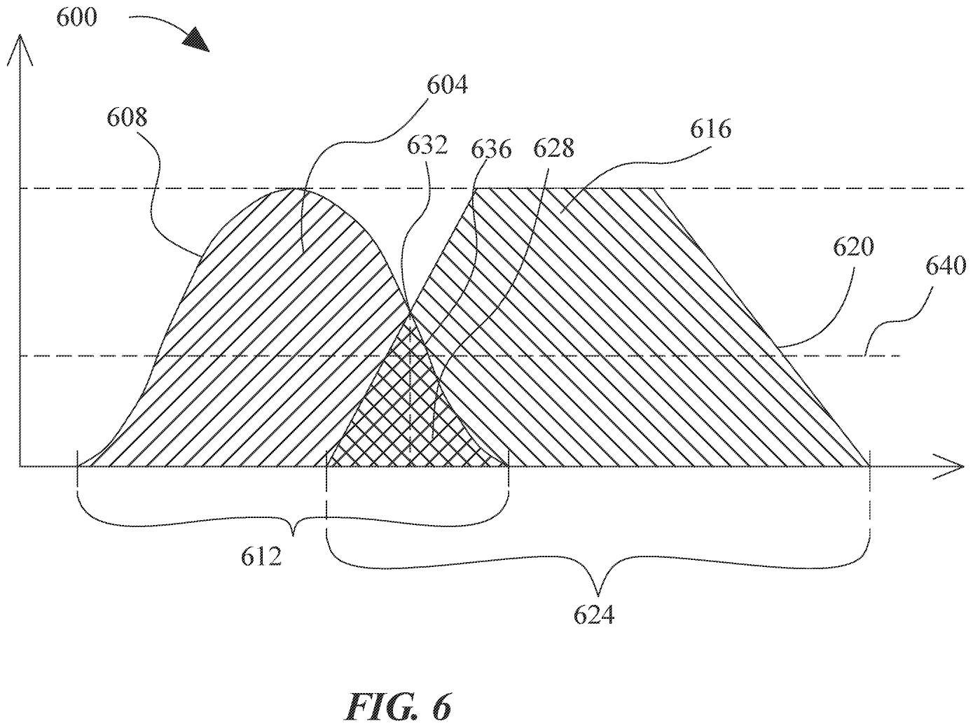

Now referring to FIG. 6, an exemplary embodiment of fuzzy set comparison 600 is illustrated. In a non-limiting embodiment, the fuzzy set comparison. In a non-limiting embodiment, fuzzy set comparison 600 may be consistent with fuzzy set comparison in FIG. 1. In another non-limiting the fuzzy set comparison 600 may be consistent with the name/version matching as described herein. For example and without limitation, the parameters, weights, and/or coefficients of the membership functions may be tuned using any machine-learning methods for the name/version matching as described herein. In another non-limiting embodiment, the fuzzy set may represent a plurality of first efficiency clusters and an ideal arrangement 128 from FIG. 1.

Alternatively or additionally, and still referring to FIG. 6, fuzzy set comparison 600 may be generated as a function of determining data compatibility threshold. The compatibility threshold may be determined by a computing device. In some embodiments, a computing device may use a logic comparison program, such as, but not limited to, a fuzzy logic.

model to determine the compatibility threshold and/or version authenticator. Each such compatibility threshold may be represented as a value for a posting variable representing the compatibility threshold, or in other words a fuzzy set as described above that corresponds to a degree of compatibility and/or allowability as calculated using any statistical, machine-learning, or other method that may occur to a person skilled in the art upon reviewing the entirety of this disclosure. In some embodiments, determining the compatibility threshold and/or version authenticator may include using a linear regression model. A linear regression model may include a machine learning model. A linear regression model may map statistics such as, but not limited to, frequency of the same range of version numbers, and the like, to the compatibility threshold and/or version authenticator. In some embodiments, determining the compatibility threshold of any posting may include using a classification model. A classification model may be configured to input collected data and cluster data to a centroid based on, but not limited to, frequency of appearance of the range of versioning numbers, linguistic indicators of compatibility and/or allowability, and the like. Centroids may include scores assigned to them such that the compatibility threshold may each be assigned a score. In some embodiments, a classification model may include a K-means clustering model. In some embodiments, a classification model may include a particle swarm optimization model. In some embodiments, determining a compatibility threshold may include using a fuzzy inference engine. A fuzzy inference engine may be configured to map one or more compatibility threshold using fuzzy logic. In some embodiments, a plurality of computing devices may be arranged by a logic comparison program into compatibility arrangements. A “compatibility arrangement” as used in this disclosure is any grouping of objects and/or data based on skill level and/or output score. Membership function coefficients and/or constants as described above may be tuned according to classification and/or clustering algorithms. For instance, and without limitation, a clustering algorithm may determine a Gaussian or other distribution of questions about a centroid corresponding to a given compatibility threshold and/or version authenticator, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Still referring to FIG. 6, inference engine may be implemented according to input a plurality of first efficiency clusters and an ideal arrangement 128. For instance, an acceptance variable may represent a first measurable value pertaining to the classification of a plurality of first efficiency clusters to an ideal arrangement 128. Continuing the example, an output variable may represent an improvement data 136 tailored to the user profile 108. In an embodiment, a plurality of first efficiency clusters and/or an ideal arrangement 128 may be represented by their own fuzzy set. In other embodiments, an evaluation factor may be represented as a function of the intersection two fuzzy sets as shown in FIG. 6, An inference engine may combine rules, such as any semantic versioning, semantic language, version ranges, and the like thereof. The degree to which a given input function membership matches a given rule may be determined by a triangular norm or “T-norm” of the rule or output function with the input function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “⊥,” such as max(a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$( x , a , b , c ) = \{ \begin{matrix}0 , & for x > c and x < a \\ \frac{x - a}{b - a} , & for a \leq x < b \\ \frac{c - x}{c - b} , & if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

First fuzzy set 604 may represent any value or combination of values as described above, including any a plurality of first efficiency clusters and ideal arrangement 128. A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 636 that overlaps, first membership function 608 and second membership function 620 may intersect at a point 632 representing a probability, as defined on probability interval, of a match between first fuzzy set 604 and second fuzzy set 616. Alternatively or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, improvement data 136 may indicate a sufficient degree of overlap with fuzzy set representing a plurality of first efficiency clusters and an ideal arrangement 128 for combination to occur as described above. Each threshold may be established by one or more user inputs. Alternatively or additionally, each threshold may be tuned by a machine-learning and/or statistical process, for instance and without limitation as described in further detail below.

In an embodiment, a degree of match between fuzzy sets may be used to rank one resource against another. For instance, if both a plurality of first efficiency clusters and an ideal arrangement 128 have fuzzy sets, improvement data 136 may be generated by having a degree of overlap exceeding a predictive threshold, processor 104 may further rank the two resources by ranking a resource having a higher degree of match more highly than a resource having a lower degree of match. Where multiple fuzzy matches are performed, degrees of match for each respective fuzzy set may be computed and aggregated through, for instance, addition, averaging, or the like, to determine an overall degree of match, which may be used to rank resources; selection between two or more matching resources may be performed by selection of a highest-ranking resource, and/or multiple notifications may be presented to a user in order of ranking.

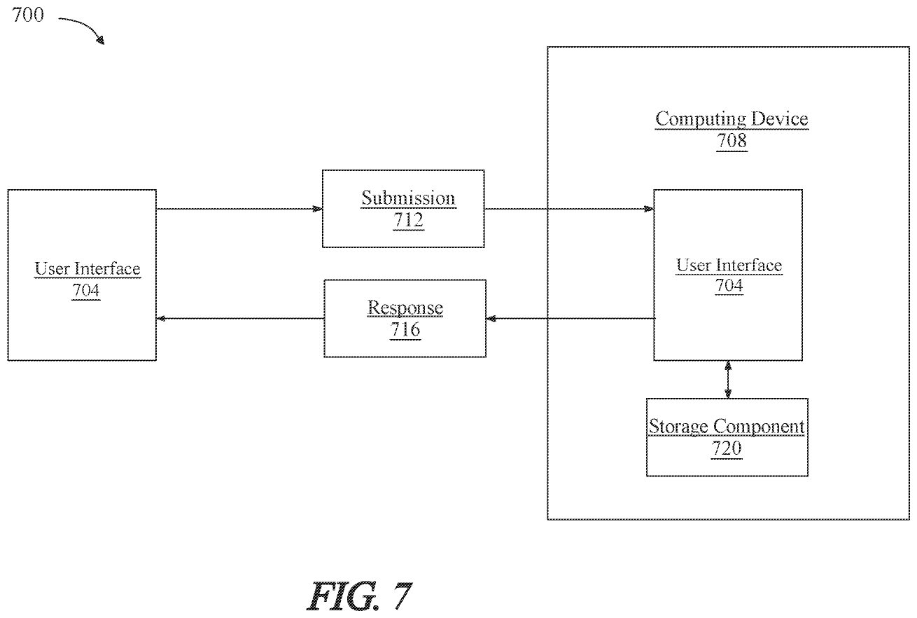

Referring to FIG. 7, a chatbot system 700 is schematically illustrated. According to some embodiments, a user interface 704 may be communicative with a computing device 708 that is configured to operate a chatbot. In some cases, user interface 704 may be local to computing device 708. Alternatively or additionally, in some cases, user interface 704 may remote to computing device 708 and communicative with the computing device 708, by way of one or more networks, such as without limitation the internet. Alternatively or additionally, user interface 704 may communicate with user device 708 using telephonic devices and networks, such as without limitation fax machines, short message service (SMS), or multimedia message service (MMS). Commonly, user interface 704 communicates with computing device 708 using text-based communication, for example without limitation using a character encoding protocol, such as American Standard for Information Interchange (ASCII). Typically, a user interface 704 conversationally interfaces a chatbot, by way of at least a submission 712, from the user interface 708 to the chatbot, and a response 716, from the chatbot to the user interface 704. In many cases, one or both of submission 712 and response 716 are text-based communication. Alternatively or additionally, in some cases, one or both of submission 712 and response 716 are audio-based communication.

Continuing in reference to FIG. 7, a submission 712 once received by computing device 708 operating a chatbot, may be processed by a processor. In some embodiments, processor processes a submission 7112 using one or more of keyword recognition, pattern matching, and natural language processing. In some embodiments, processor employs real-time learning with evolutionary algorithms. In some cases, processor may retrieve a pre-prepared response from at least a storage component 720, based upon submission 712. Alternatively or additionally, in some embodiments, processor communicates a response 716 without first receiving a submission 712, thereby initiating conversation. In some cases, processor communicates an inquiry to user interface 704; and the processor is configured to process an answer to the inquiry in a following submission 712 from the user interface 704. In some cases, an answer to an inquiry present within a submission 712 from a user device 704 may be used by computing device 708 as an input to another function.

With continued reference to FIG. 7, A chatbot may be configured to provide a user with a plurality of options as an input into the chatbot. Chatbot entries may include multiple choice, short answer response, true or false responses, and the like. A user may decide on what type of chatbot entries are appropriate. In some embodiments, the chatbot may be configured to allow the user to input a freeform response into the chatbot. The chatbot may then use a decision tree, data base, or other data structure to respond to the users entry into the chatbot as a function of a chatbot input. As used in the current disclosure, “Chatbot input” is any response that a candidate or employer inputs into a chatbot as a response to a prompt or question.

With continuing reference to FIG. 7, computing device 708 may be configured to the respond to a chatbot input using a decision tree. A “decision tree,” as used in this disclosure, is a data structure that represents and combines one or more determinations or other computations based on and/or concerning data provided thereto, as well as earlier such determinations or calculations, as nodes of a tree data structure where inputs of some nodes are connected to outputs of others. Decision tree may have at least a root node, or node that receives data input to the decision tree, corresponding to at least a candidate input into a chatbot. Decision tree has at least a terminal node, which may alternatively or additionally be referred to herein as a “leaf node,” corresponding to at least an exit indication; in other words, decision and/or determinations produced by decision tree may be output at the at least a terminal node. Decision tree may include one or more internal nodes, defined as nodes connecting outputs of root nodes to inputs of terminal nodes. Computing device 708 may generate two or more decision trees, which may overlap; for instance, a root node of one tree may connect to and/or receive output from one or more terminal nodes of another tree, intermediate nodes of one tree may be shared with another tree, or the like.

Still referring to FIG. 7, computing device 708 may build decision tree by following relational identification; for example, relational indication may specify that a first rule module receives an input from at least a second rule module and generates an output to at least a third rule module, and so forth, which may indicate to computing device 708 an in which such rule modules will be placed in decision tree. Building decision tree may include recursively performing mapping of execution results output by one tree and/or subtree to root nodes of another tree and/or subtree, for instance by using such execution results as execution parameters of a subtree. In this manner, computing device 708 may generate connections and/or combinations of one or more trees to one another to define overlaps and/or combinations into larger trees and/or combinations thereof. Such connections and/or combinations may be displayed by visual interface to user, for instance in first view, to enable viewing, editing, selection, and/or deletion by user; connections and/or combinations generated thereby may be highlighted, for instance using a different color, a label, and/or other form of emphasis aiding in identification by a user. In some embodiments, subtrees, previously constructed trees, and/or entire data structures may be represented and/or converted to rule modules, with graphical models representing them, and which may then be used in further iterations or steps of generation of decision tree and/or data structure. Alternatively or additionally subtrees, previously constructed trees, and/or entire data structures may be converted to APIs to interface with further iterations or steps of methods as described in this disclosure. As a further example, such subtrees, previously constructed trees, and/or entire data structures may become remote resources to which further iterations or steps of data structures and/or decision trees may transmit data and from which further iterations or steps of generation of data structure receive data, for instance as part of a decision in a given decision tree node.

Continuing to refer to FIG. 7, decision tree may incorporate one or more manually entered or otherwise provided decision criteria. Decision tree may incorporate one or more decision criteria using an application programmer interface (API). Decision tree may establish a link to a remote decision module, device, system, or the like. Decision tree may perform one or more database lookups and/or look-up table lookups. Decision tree may include at least a decision calculation module, which may be imported via an API, by incorporation of a program module in source code, executable, or other form, and/or linked to a given node by establishing a communication interface with one or more exterior processes, programs, systems, remote devices, or the like; for instance, where a user operating system has a previously existent calculation and/or decision engine configured to make a decision corresponding to a given node, for instance and without limitation using one or more elements of domain knowledge, by receiving an input and producing an output representing a decision, a node may be configured to provide data to the input and receive the output representing the decision, based upon which the node may perform its decision.

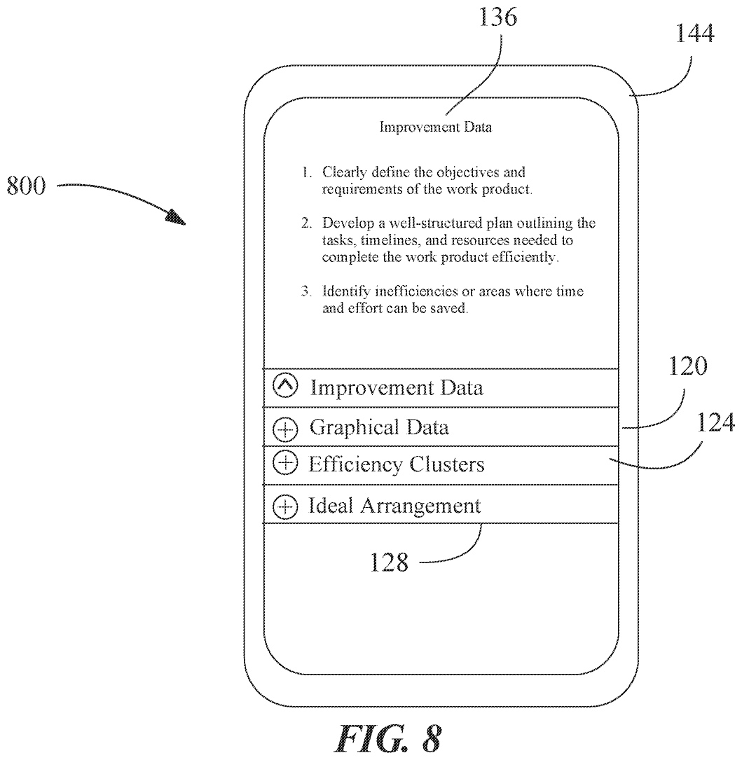

Now referring to FIG. 8, an exemplary representation of a user interface component is presented. User interface 800 may include a display device such as display device 144. In an embodiment, user interface 800 may display improvement data 136. In an embodiment, user interface 800 may display step by step instructions or suggestions on how to improve efficiency data 116. In an example, without limitations, user interface 800 may display a graphical representation the efficiency data 116. This may include trendlines depicting how the user's efficiency data 116 is improving and the rate at which they are improving. In some embodiments, user interface 800 may display a plurality of questions which require the user to enter information regarding the user profile 108 and occupational data 112. User interface 800 may present a user questions to generate the user profile 108.

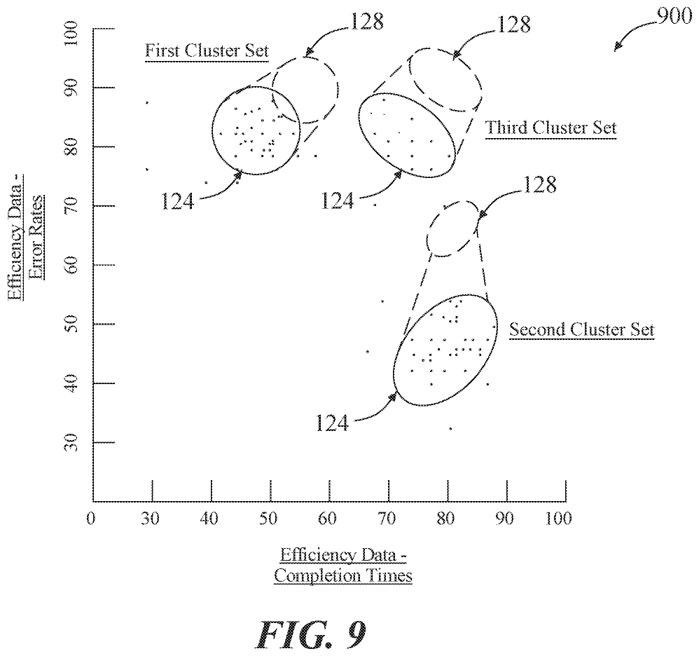

Referring now to FIG. 9, is an exemplary embodiment of a plurality of efficiency clusters. FIG. 9 depicts three cluster sets, wherein a cluster set includes incudes an efficiency cluster 124 and the ideal arrangement 128 of the efficiency cluster. FIG. 9 includes plurality of efficiency data plotted along two continuums to create an XY plot. The continuum along the X-axis may represent efficiency data associated with the completion times of the user, wherein a higher efficiency data represents a more favorable competition time, and a lower efficiency data represents a less favorable competition time. The continuum along the Y-axis may represent efficiency data associated with the error rates of the user, wherein a higher efficiency data represents a more favorable error rate, and a lower efficiency data represents a less favorable error rate. In an embodiment, each of the three efficiency cluster sets may represent the efficiency data associated with a user or set of users over a period of time as a function of the combined error rate and the completion times. In another embodiment, each cluster set may represent a group of employees who have similar efficiency data. Processor 104 may be used to identify commonalities between the group of employees within the efficiency cluster such as education, job title, tenure, past job performance, and the like. The ideal arrangement 128 of each of the efficiency clusters 124 may represent a performance goal for the group of employees. Each ideal arrangement 124 may be configured to be smaller in size as compared to the efficiency cluster 124 to represent more consistent efficiency data for the entire group. In a non-limiting example, the first cluster set may represent a set of efficiency data associated with a first group of employees, wherein the first group of employees includes employees who have relatively no job experience. The ideal arrangement 128 of the efficiency cluster may represent the performance benchmark or goal for the entire group.

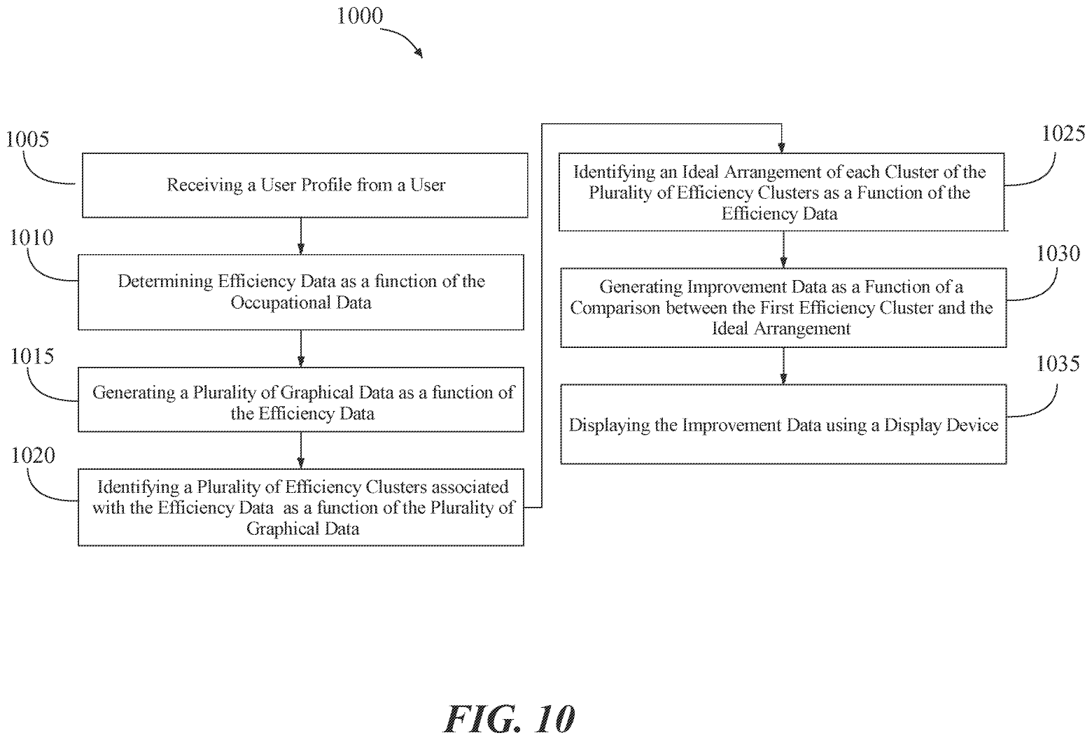

Referring now to FIG. 10, a flow diagram of an exemplary method 1000 for the generation and improvement of efficiency data is illustrated. At step 1005, method 1000 includes receiving, using at least a processor, a user profile from a user, wherein the user profile comprises occupational data. This may be implemented as described and with reference to FIGS. 1-9. In some embodiments, extracting the user profile may comprise receiving the user profile using a web crawler or a chatbot.

Still referring to FIG. 10, at step 1010, method 1000 includes determining, using the at least a processor, efficiency data as a function of the occupational data. This may be implemented as described and with reference to FIGS. 1-9. In an embodiment, the method may further include classifying, using the at least a processor, the occupational data into one or more efficiency categories. In an embodiment, the method may further include generating, using the at least a processor, an estimated completion time as a function of the occupational data.

Still referring to FIG. 10, at step 1015, method 1000 includes generating, using the at least a processor, a plurality of graphical data as a function of the efficiency data. This may be implemented as described and with reference to FIGS. 1-9.

Still referring to FIG. 10, at step 1020, method 1000 includes identifying, using the at least a processor, a plurality of efficiency clusters associated with the efficiency data as a function of the plurality of graphical data, wherein the plurality of efficiency clusters comprises a first efficiency cluster. This may be implemented as described and with reference to FIGS. 1-9. In an embodiment, identifying the plurality of efficiency clusters may include projecting each cluster of the plurality of efficiency clusters onto a continuum.

Still referring to FIG. 10, at step 1025, method 1000 includes identifying, using the at least a processor, an ideal arrangement of each cluster of the plurality of efficiency clusters as a function of the efficiency data. This may be implemented as described and with reference to FIGS. 1-9.

Still referring to FIG. 10, at step 1030, method 1000 includes generating, using the at least a processor, improvement data as a function of a comparison between the first efficiency cluster and the ideal arrangement. This may be implemented as described and with reference to FIGS. 1-9. In an embodiment, the method includes generating, using the at least a processor, the improvement data using an improvement machine learning model. The improvement machine learning model may be configured to be trained using improvement training data, wherein the improvement training data contains a plurality of data entries containing a plurality of first efficiency clusters and a plurality of ideal arrangements as an input correlated to the improvement data as an output. In another embodiment, the method further includes generating, using the at least a processor, the improvement data as a function of a comparison between the first cluster and the ideal arrangement using a fuzzy inference set. In an additional embodiment, the improvement data may include suggestions to improve the efficiency data.

Still referring to FIG. 10, at step 1035, method 1000 includes displaying the improvement data using a display device. This may be implemented as described and with reference to FIGS. 1-9.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

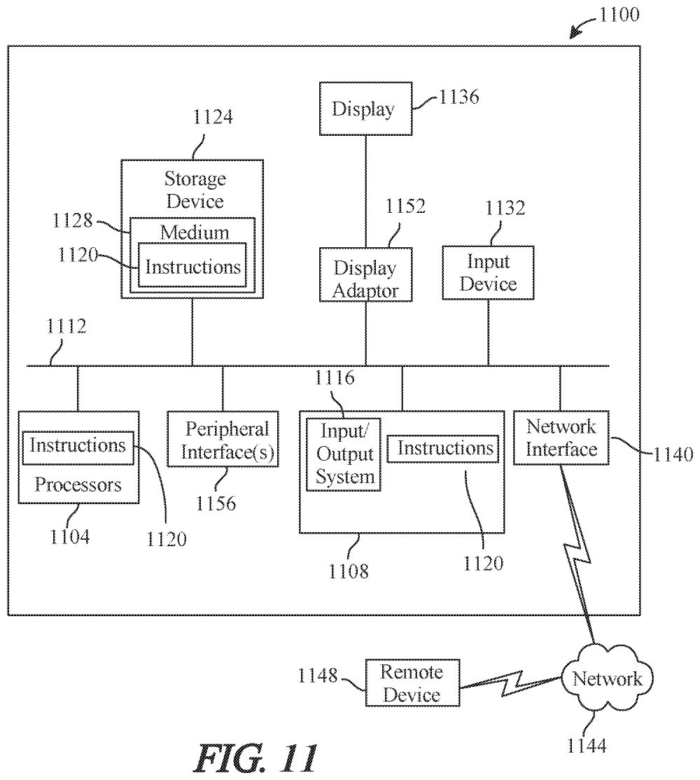

FIG. 11 shows a diagrammatic representation of one embodiment of a computing device in the exemplary form of a computer system 1100 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1100 includes a processor 1104 and a memory 1108 that communicate with each other, and with other components, via a bus 1112. Bus 1112 may include any of several types of bus structures including, but not limited to, a memory bus, a memory controller, a peripheral bus, a local bus, and any combinations thereof, using any of a variety of bus architectures.

Processor 1104 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1104 may be organized according to Von Neumann and/or Harvard architecture as a non-limiting example. Processor 1104 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1108 may include various components (e.g., machine-readable media) including, but not limited to, a random-access memory component, a read only component, and any combinations thereof. In one example, a basic input/output system 1116 (BIOS), including basic routines that help to transfer information between elements within computer system 1100, such as during start-up, may be stored in memory 1108. Memory 1108 may also include (e.g., stored on one or more machine-readable media) instructions (e.g., software) 1120 embodying any one or more of the aspects and/or methodologies of the present disclosure. In another example, memory 1108 may further include any number of program modules including, but not limited to, an operating system, one or more application programs, other program modules, program data, and any combinations thereof.

Computer system 1100 may also include a storage device 1124. Examples of a storage device (e.g., storage device 1124) include, but are not limited to, a hard disk drive, a magnetic disk drive, an optical disc drive in combination with an optical medium, a solid-state memory device, and any combinations thereof. Storage device 1124 may be connected to bus 1112 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1124 (or one or more components thereof) may be removably interfaced with computer system 1100 (e.g., via an external port connector (not shown)). Particularly, storage device 1124 and an associated machine-readable medium 1128 may provide nonvolatile and/or volatile storage of machine-readable instructions, data structures, program modules, and/or other data for computer system 1100. In one example, software 1120 may reside, completely or partially, within machine-readable medium 1128. In another example, software 1120 may reside, completely or partially, within processor 1104.

Computer system 1100 may also include an input device 1132. In one example, a user of computer system 1100 may enter commands and/or other information into computer system 1100 via input device 1132. Examples of an input device 1132 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1132 may be interfaced to bus 1112 via any of a variety of interfaces (not shown) including, but not limited to, a serial interface, a parallel interface, a game port, a USB interface, a FIREWIRE interface, a direct interface to bus 1112, and any combinations thereof. Input device 1132 may include a touch screen interface that may be a part of or separate from display 1136, discussed further below. Input device 1132 may be utilized as a user selection device for selecting one or more graphical representations in a graphical interface as described above.

A user may also input commands and/or other information to computer system 1100 via storage device 1124 (e.g., a removable disk drive, a flash drive, etc.) and/or network interface device 1140. A network interface device, such as network interface device 1140, may be utilized for connecting computer system 1100 to one or more of a variety of networks, such as network 1144, and one or more remote devices 1148 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. A network, such as network 1144, may employ a wired and/or a wireless mode of communication. In general, any network topology may be used. Information (e.g., data, software 1120, etc.) may be communicated to and/or from computer system 1100 via network interface device 1140.

Computer system 1100 may further include a video display adapter 1152 for communicating a displayable image to a display device, such as display device 1136. Examples of a display device include, but are not limited to, a liquid crystal display (LCD), a cathode ray tube (CRT), a plasma display, a light emitting diode (LED) display, and any combinations thereof. Display adapter 1152 and display device 1136 may be utilized in combination with processor 1104 to provide graphical representations of aspects of the present disclosure. In addition to a display device, computer system 1100 may include one or more other peripheral output devices including, but not limited to, an audio speaker, a printer, and any combinations thereof. Such peripheral output devices may be connected to bus 1112 via a peripheral interface 1156. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

1. An apparatus for a generation and improvement of efficiency data, wherein the apparatus comprises:
at least a processor; and
a memory communicatively connected to the at least a processor, wherein the memory containing instructions configuring the at least a processor to:
receive a user profile from a user, wherein the user profile comprises occupational data, wherein the user profile further comprises at least a user record, and wherein the at least a user record is pre-processed using an optical character reader configured to convert images of the at least a user record into machine-encoded text;
train an efficiency machine learning model using efficiency training data, wherein training the efficiency machine learning model comprises:
applying the efficiency training data to an input layer of nodes comprising the occupational data, one or more intermediate layers of nodes, and an output layer of nodes comprising examples of efficiency data outputs;
adjusting one or more connections and one or more weights between nodes in adjacent layers of the efficiency machine learning model;
detecting additional correlations between the output layer of nodes and the input layer of nodes;
iteratively updating the efficiency machine learning model as a function of he detected additional correlations;
retraining the efficiency machine learning model as a function of user feedback wherein the user feedback indicates a quality of the examples of efficiency data outputs;
generate efficiency data as a function of the trained efficiency machine learning model;
generate a plurality of graphical data as a function of the efficiency data;
identify a plurality of efficiency clusters associated with the efficiency data as a function of the plurality of graphical data, wherein the plurality of efficiency clusters comprises a first efficiency cluster;
identify an ideal arrangement of each cluster of the plurality of efficiency clusters as a function of the efficiency data;
generate user improvement data as a function of a comparison between the first efficiency cluster and the ideal arrangement;
generate a notification as a function of the efficiency data and the user improvement data, wherein the notification is further generated as a function of an efficiency threshold, wherein the efficiency threshold is calculated using the user improvement data; and
display the improvement data using a display device.

2. The apparatus of claim 1, wherein receiving the user profile from a user comprises receiving the user profile from a web crawler.

3. The apparatus of claim 1, wherein receiving the user profile from a user comprises receiving the user profile from a chatbot.

4. The apparatus of claim 1, wherein identifying the plurality of efficiency clusters comprises projecting each cluster of the plurality of efficiency clusters onto a continuum, wherein the continuum is associated with an error rate of the user.

5. (canceled)

6. (canceled)

7. The apparatus of claim 1, wherein generating the improvement data comprises generating the improvement data as a function of a comparison between the first cluster and the ideal arrangement using a fuzzy inference set.

8. The apparatus of claim 1, wherein the memory further instructs the processor to classify the occupational data into one or more efficiency categories.

9. The apparatus of claim 8, wherein classifying the occupational data into the one or more efficiency categories comprises classifying the occupational data using the efficiency machine learning model.

10. The apparatus of claim 1, wherein the memory further instructs the processor to:
identify one or more tasks associated with the user as a function of the occupational data, wherein the occupational data comprises a listing of a plurality of tasks associated with the user; and
generate an estimated completion time as a function of the identification of the one or more tasks associated with the user.

11. A method for a generation and improvement of efficiency data, wherein the method comprises:
receiving, using at least a processor, a user profile from a user, wherein the user profile comprises occupational data, wherein the user profile further comprises at least a user record wherein the at least a user record is pre-processed using an optical character reader configured to convert images of the at least a user record into machine-encoded text;
training, using the at least a processor, an efficiency machine learning model using efficiency training data, wherein training the efficiency machine learning model comprises:
applying the efficiency training data to an input layer of nodes comprising the occupational data, one or more intermediate layers of nodes, and an output layer of nodes comprising examples of efficiency data outputs;
adjusting one or more connections and one or more weights between nodes in adjacent layers of the efficiency machine learning model;
detecting additional correlations between the output layer of nodes and the input layer of nodes;
iteratively updating the efficiency machine learning model as a function of he detected additional correlations;
retraining the efficiency machine learning model as a function of user feedback wherein the user feedback indicates a quality of the examples of efficiency data outputs;
generating, using the at least a processor, efficiency data as a function of the trained efficiency machine learning model;
generating, using the at least a processor, a plurality of graphical data as a function of the efficiency data;
identifying, using the at least a processor, a plurality of efficiency clusters associated with the efficiency data as a function of the plurality of graphical data, wherein the plurality of efficiency clusters comprises a first efficiency cluster;
identifying, using the at least a processor, an ideal arrangement of each cluster of the plurality of efficiency clusters as a function of the efficiency data;
generating, using the at least a processor, user improvement data as a function of a comparison between the first efficiency cluster and the ideal arrangement;
generating, using the at least a processor, a notification as a function of the efficiency data and the user improvement data, wherein the notification is further generated as a function of an efficiency threshold, wherein the efficiency threshold is calculated using the user improvement data; and
displaying the improvement data using a display device.

12. The method of claim 11, wherein receiving the user profile from a user comprises receiving the user profile from a web crawler.

13. The method of claim 11, wherein receiving the user profile from a user comprises receiving the user profile from a chatbot.

14. The method of claim 11, wherein identifying the plurality of efficiency clusters comprises projecting each cluster of the plurality of efficiency clusters onto a continuum, wherein the continuum is associated with an error rate of the user.

15. (canceled)

16. (canceled)

17. The method of claim 11, wherein the method further comprises generating, using the at least a processor, the improvement data as a function of a comparison between the first cluster and the ideal arrangement using a fuzzy inference set.

18. The method of claim 11, wherein the method further comprises classifying, using the at least a processor, the occupational data into one or more efficiency categories.

19. The method of claim 18, wherein classifying, using the at least a processor, the occupational data into the one or more efficiency categories comprises classifying the occupational data using the efficiency machine learning model.

20. The method of claim 11, wherein the method further comprises:
identifying, using the at least a processor, one or more tasks associated with the user as a function of the occupational data, wherein the occupational data comprises a listing of a plurality of tasks associated with the user; and
generating, using the at least a processor, an estimated completion time as a function of the identification of the one or more tasks associated with the user.
